(19) United States
(12) Patent Application Publication
(10) Pub. No.: US 2023/0134634 A1
(43) Pub. Date: May 4, 2023

(54) ANOMALY DETECTION SYSTEM, ANOMALY DETECTION APPARATUS, AND ANOMALY DETECTION METHOD

(71) Applicant: NEC Corporation, Minato-ku, Tokyo (JP)

(72) Inventor: Ayumi KOBAYASHI, Tokyo (JP)

(73) Assignee: Minato-ku, Tokyo, Minato-ku, Tokyo (JP)

(21) Appl. No.: 17/910,899

(22) PCT Filed: Mar. 26, 2021
(86) PCT No.: PCT/JP2021/013108

§ 371 Date: Sep. 12, 2022

(30) Foreign Application Priority Data
Mar. 30, 2020 (JP) 2020-060394

(51) Int. Cl. G01H 9/00; B60L 13/04; G01V 7/04

(52) U.S. Cl. CPC G01H 9/00; B60L 13/04; G01V 7/04

(57) ABSTRACT

An anomaly detection system according to the present disclosure includes: an optical fiber (10) configured to detect a state of a metal wire (20) affected by a magnetic force generated between a vehicle (60) and a guideway (50) of a magnetically levitated train; a reception unit (30) configured to receive, from the optical fiber (10), an optical signal including information indicating an effect of the magnetic force received by the metal wire (20); and a detection unit (42) configured to detect an anomaly of the vehicle (60) or the guideway (50) based on the information indicating the effect of the magnetic force received by the metal wire (20), the information being included in the optical signal.

### TECHNICAL FIELD

The present disclosure relates to an anomaly detection system, an anomaly detection apparatus, and an anomaly detection method.

### BACKGROUND ART

A magnetically levitated train travels by levitating and propelling its vehicle body from a track using repulsive and attractive forces of a magnetic force. A typical example of the magnetically levitated train is a linear bullet train that uses the attraction and repulsion action of a superconducting magnet installed in the magnetically levitated train on the vehicle side thereof and a coil installed in the magnetically levitated train on the guideway side thereof.

In recent years, progress in the practical application (commercialization) of a linear bullet train has been made, and safety measures such as maintenance of the vehicle and the guideway of a magnetically levitated train have been studied accordingly.

For example, Patent Literature 1 discloses a technique for safely operating the vehicle of a magnetically levitated train. Specifically, in Patent Literature 1, an optical fiber is laid along a side wall panel including a track on which the vehicle travels, and the strain of the track generated by an earthquake or the like is measured by using the optical fiber as a strain sensor. When it is determined that an anomaly has occurred based on a result of the measurement by the optical fiber, reduction of the speed of the vehicle, stopping of the vehicle, or the like are performed.

### CITATION LIST

### Patent Literature

Patent Literature 1: Japanese Unexamined Patent Application Publication No.

### SUMMARY OF INVENTION

### Technical Problem

According to the technique disclosed in Patent Literature 1, when a disaster such as an earthquake has occurred, the vehicle of a magnetically levitated train can be safely operated. However, Patent Literature 1 does not disclose that an anomaly which has occurred in the vehicle or the guideway of the magnetically levitated train can be detected.

Therefore, an object of the present disclosure is to provide an anomaly detection system, an anomaly detection apparatus, and an anomaly detection method that are capable of solving the above-described problem, and detecting an anomaly which has occurred in the vehicle or the guideway of a magnetically levitated train.

### Solution to Problem

An anomaly detection system according to an example aspect includes:

an optical fiber configured to detect a state of a metal member affected by a magnetic force generated between a vehicle and a guideway of a magnetically levitated train;

a reception unit configured to receive, from the optical fiber, an optical signal including information indicating an effect of the magnetic force received by the metal member; and

a detection unit configured to detect an anomaly of the vehicle or the guideway based on the information indicating the effect of the magnetic force received by the metal member, the information being included in the optical signal.

An anomaly detection apparatus according to an example aspect includes:

an acquisition unit configured to acquire information indicating an effect of a magnetic force received by a metal member, the information being included in an optical signal received from an optical fiber configured to detect a state of the metal member affected by the magnetic force generated between a vehicle and a guideway of a magnetically levitated train; and

a detection unit configured to detect an anomaly of the vehicle or the guideway based on the information indicating the effect of the magnetic force received by the metal member.

An anomaly detection method according to an example aspect is an anomaly detection method performed by an anomaly detection system, the anomaly detection method including:

a reception step of receiving, from an optical fiber configured to detect a state of a metal member affected by a magnetic force generated between a vehicle and a guideway of a magnetically levitated train, an optical signal including information indicating an effect of the magnetic force received by the metal member; and

a detection step of detecting an anomaly of the vehicle or the guideway based on the information indicating the effect of the magnetic force received by the metal member, the information being included in the optical signal.

### Advantageous Effects of Invention

In accordance with the above-described example aspects, it is possible to achieve an effect that an anomaly detection system, an anomaly detection apparatus, and an anomaly detection method that are capable of detecting an anomaly which has occurred in the vehicle or the guideway of a magnetically levitated train can be provided.

### BRIEF DESCRIPTION OF DRAWINGS

FIG. 1 is a diagram showing the principle of a magnetically levitated train;

FIG. 2 is a diagram showing the principle of the magnetically levitated train;

FIG. 3 is a diagram showing a configuration example of an anomaly detection system according to a first example embodiment;

FIG. 4 is a diagram showing an example of a state in which an optical fiber and a metal wire according to the first example embodiment are installed on a guideway side;

FIG. 5 is a diagram showing an example of the state in which the optical fiber and the metal wire according to the first example embodiment are installed on the guideway side;

FIG. 6 is a diagram showing an example of a state in which the optical fiber and the metal wire according to the first example embodiment are installed on a vehicle side;

FIG. 7 is a diagram showing an example of the state in which the optical fiber and the metal wire according to the first example embodiment are installed on the vehicle side;

FIG. 8 is a diagram showing a modified configuration example of the anomaly detection system according to the first example embodiment;

FIG. 9 is a flow diagram showing an example of a flow of operations performed by the anomaly detection system according to the first example embodiment;

FIG. 10 is a diagram showing an example of a method by which a detection unit according to a second example embodiment determines whether an anomaly has occurred in the vehicle or it has occurred in the guideway when the optical fiber and the metal wire are installed on the guideway side;

FIG. 11 is a diagram showing an example of a method by which the detection unit according to the second example embodiment determines whether an anomaly has occurred in the vehicle or it has occurred in the guideway when the optical fiber and the metal wire are installed on the vehicle side;

FIG. 12 is a flow diagram showing an example of a flow of operations performed by the anomaly detection system according to the second example embodiment;

FIG. 13 is a diagram showing a configuration example of an anomaly detection system according to a third example embodiment;

FIG. 14 is a flow diagram showing an example of a flow of operations performed by the anomaly detection system according to the third example embodiment;

FIG. 15 is a diagram showing a configuration example of an anomaly detection system according to another example embodiment; and

FIG. 16 is a block diagram showing an example of a hardware configuration of a computer that implements the anomaly detection apparatus according to the example embodiments.

### EXAMPLE EMBODIMENT

Example embodiments of the present disclosure will be described hereinafter with reference to the drawings. Note that, for the clarification of the description, the following descriptions and the drawings are partially omitted and simplified as appropriate. Further, the same elements are denoted by the same reference symbols throughout the drawings, and redundant descriptions are omitted as necessary.

### First Example Embodiment

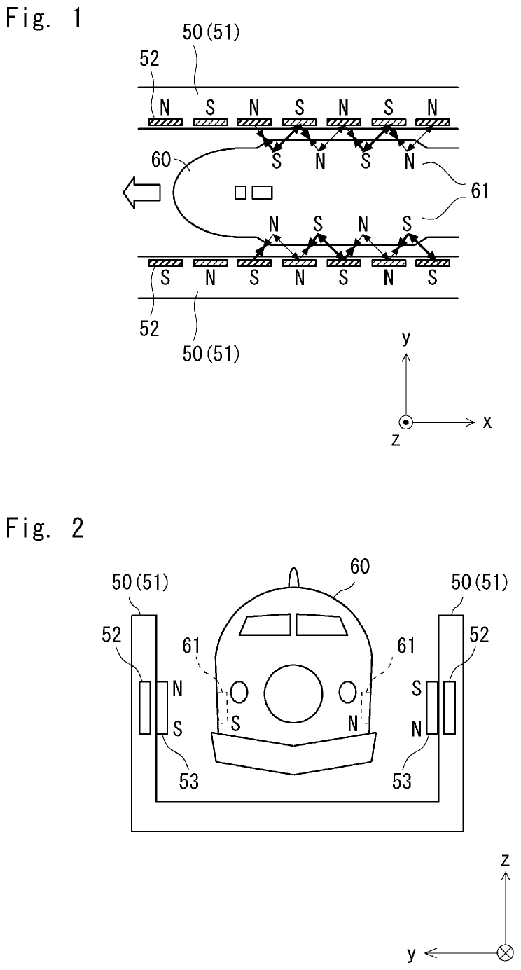

Prior to describing a first example embodiment, the principle of a magnetically levitated train will be briefly described with reference to FIGS. 1 and 2. FIG. 1 is a top view of a vehicle 60 of a magnetically levitated train (hereinafter referred to simply as a “vehicle 60” as appropriate) and a guideway 50 of the magnetically levitated train, while FIG. 2 is a front view of the vehicle 60 and the guideway 50.

As shown in FIGS. 1 and 2, the guideway 50 is a traveling path of the vehicle 60, and the vehicle 60 travels in the guideway 50.

As shown in FIG. 1, superconducting magnets 61 are installed in the inner side surfaces of the vehicle 60 on the left and right sides thereof (both sides thereof in the y direction) along the direction (the x direction) in which the guideway 50 is extended so that the north and south poles of the superconducting magnets 61 are alternately arranged. A magnetic field is generated by making an electric current pass through the superconducting magnets 61.

Propulsion coils 52 are installed on side walls 51 of the guideway 50 on the left and right sides thereof (both sides thereof in the y direction) along the direction (the x direction) in which the guideway 50 is extended. In accordance with the movement of the vehicle 60, a magnetic field is generated by making a current pass through the propulsion coils 52 and the magnetic poles of the propulsion coils 52 are switched. By doing so, a pushing force (a repulsive force) and a pulling force (an attractive force) are generated between the superconducting magnet 61 and the propulsion coil 52. As a result, the vehicle 60 moves forward.

Further, as shown in FIG. 2, levitation/guide coils 53 are installed on the side walls 51 of the guideway 50 on the left and right sides thereof (both sides thereof in the y-direction) along the direction (the x direction) in which the guideway 50 is extended so that the levitation/guide coils 53 are closer to the vehicle 60 side (the positive side or the negative side in the y-direction) than the propulsion coil 52. When the superconducting magnet 61 of the vehicle 60 approaches the levitation/guide coil 53, an induction current flows in the levitation/guide coil 53 and this levitation/guide coil 53 becomes an electromagnet. By the above, a force (a repulsive force) for pushing up the vehicle 60 from below and a force (an attractive force) for pulling up the vehicle 60 are generated between the superconducting magnet 61 and the levitation/guide coil 53. As a result, the vehicle 60 is levitated.

Further, when the vehicle 60 is shifted to one side wall 51 of the guideway 50 (a positive side or a negative side thereof in the y direction), a repulsive force is exerted between the superconducting magnet 61 and the levitation/guide coil 53 on the one side wall 51, and an attractive force is exerted between the superconducting magnet 61 and the levitation/guide coil 53 on the other side wall 51. As a result, the vehicle 60 is returned to the vicinity of the right and left center of the guideway 50 (the vicinity of the center thereof in the y direction).

An anomaly detection system according to the first example embodiment is a system that detects an anomaly of the vehicle 60 or the guideway 50 described above.

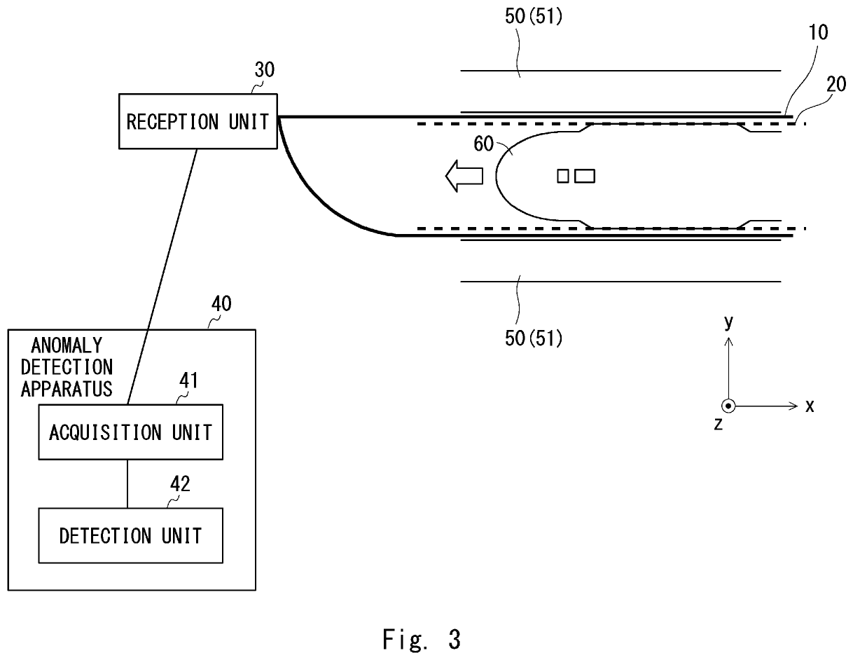

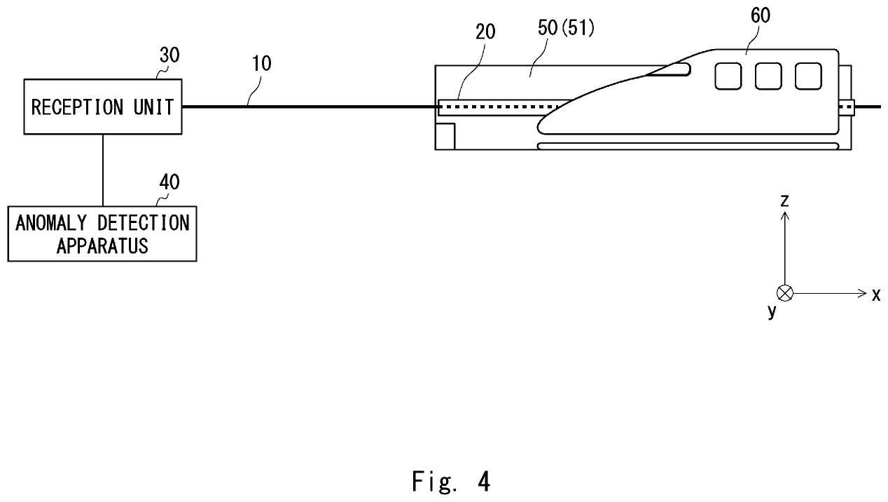

Next, a configuration example of the anomaly detection system according to the first example embodiment will be described with reference to FIG. 3. FIG. 3 shows a top view of the vehicle 60 and the guideway 50. Further, in FIG. 3, in order to simplify the drawing, the superconducting magnet 61 installed in the vehicle 60 and the propulsion coil 52 and the levitation/guide coil 53 installed in the guideway 50 are not shown (the same applies to FIGS. 4 to 7 and 13 described below).

As shown in FIG. 3, the anomaly detection system according to the first example embodiment includes an optical fiber 10, a reception unit 30, and an anomaly detection apparatus 40. Further, the anomaly detection apparatus 40 includes an acquisition unit 41 and a specification unit 32. Note that the anomaly detection apparatus 40 can be disposed at a position distant from the reception unit 30. For example, it can be disposed in a cloud.

The optical fiber 10 is installed together with a metal wire 20 between the vehicle 60 and each of the side walls 51 of the guideway 50 on the left and right sides thereof (both sides thereof in the y direction) along the direction (the x direction) in which the guideway 50 is extended in such a manner that the optical fiber 10 is in close contact with the metal wire 20.

The metal wire 20 is made of a magnetic material such as iron, nickel, or cobalt that reacts with a magnetic force, and is brought into close contact with the optical fiber 10 as described above. However, the shape of metal with which the optical fiber 10 is brought into close contact is not limited to a linear shape. Therefore, a metal member having a shape other than a linear shape may be installed instead of the metal wire 20.

Conceivable states in which the optical fiber 10 and the metal wire 20 are installed can be broadly divided into two: a state in which they are installed on the guideway 50 side and a state in which they are installed on the vehicle 60 side.

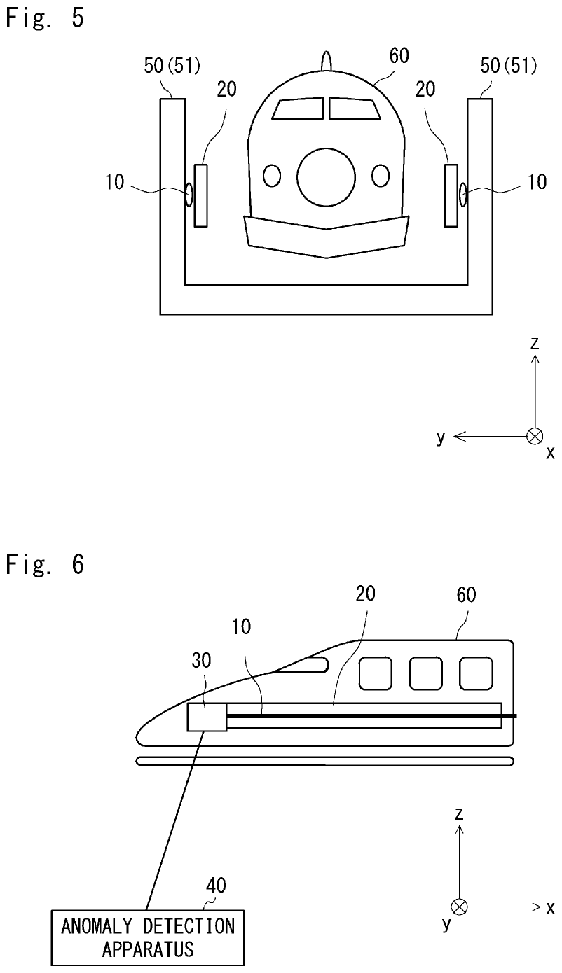

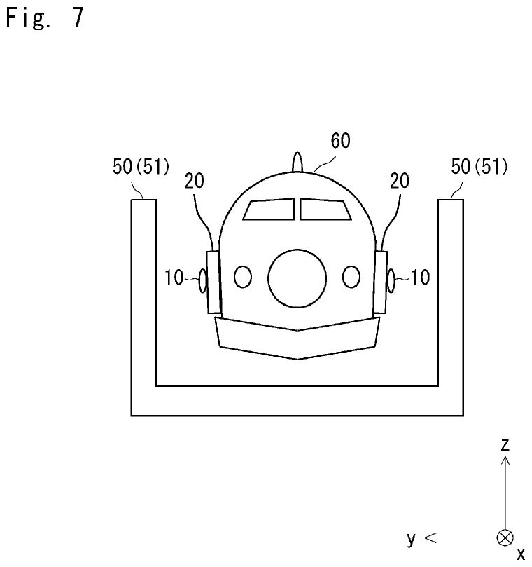

First, an example of the state in which the optical fiber 10 and the metal wire 20 are installed on the guideway 50 side will be described with reference to FIGS. 4 and 5. FIG. 4 shows a side view of the vehicle 60 and the guideway 50, while FIG. 5 shows a front view of the vehicle 60 and the guideway 50. Note that, in FIG. 5, the reception unit 30 and the anomaly detection apparatus 40 are not shown (the same applies to FIG. 7 described below).

As shown in FIGS. 4 and 5, the optical fiber 10 and the metal wire 20 are installed on the side walls 51 of the guideway 50 on the left and right sides thereof (on both sides thereof in the y direction) along the direction (the x direction) in which the guideway 50 is extended. Note that, as described later, the metal wire 20 is installed in order to apply a magnetic force generated between the superconducting magnet 61 installed in the vehicle 60 and the propulsion coil 52 and the levitation/guide coil 53 installed on each of the side walls 51 of the guideway 50 on the left and right side thereof. Therefore, more particularly, the optical fiber 10 and the metal wire 20 are preferably installed between the superconducting magnet 61 and the propulsion coil 52 and the levitation/guide coil 53. Note that in the state in which the optical fiber 10 and the metal wire 20 are installed on the guideway 50 side, the reception unit 30 is disposed outside the vehicle 60.

Next, an example of the state in which the optical fiber 10 and the metal wire 20 are installed on the vehicle 60 side will be described with reference to FIGS. 6 and 7. FIG. 6 shows a side view of the vehicle 60 and the guideway 50, while FIG. 7 shows a front view of the vehicle 60 and the guideway 50.

As shown in FIGS. 6 and 7, the optical fiber 10 and the metal wire 20 are installed on the outer side surfaces of the vehicle 60 on the left and right sides thereof (on both sides thereof in the y direction) along the direction (the x direction) in which the guideway 50 is extended. In this example, like in the cases of FIGS. 4 and 5, the optical fiber 10 and the metal wire 20 are preferably installed between the superconducting magnet 61 and the propulsion coil 52 and the levitation/guide coil 53. Note that in the state in which the optical fiber 10 and the metal wire 20 are installed on the vehicle 60 side, the reception unit 30 is disposed inside the vehicle 60.

Note that, in FIGS. 4 to 7, although the optical fiber 10 is disposed closer to the sides of the side walls 51 of the guideway 50 (the positive side or the negative side in the y direction) than the metal wire 20 is, the present disclosure is not limited thereto. The optical fiber 10 may be disposed closer to the vehicle 60 side (the negative side or the positive side in the y direction) than the metal wire 20 is. Further, the optical fiber 10 may be disposed at the upper or lower end of the metal wire 20.

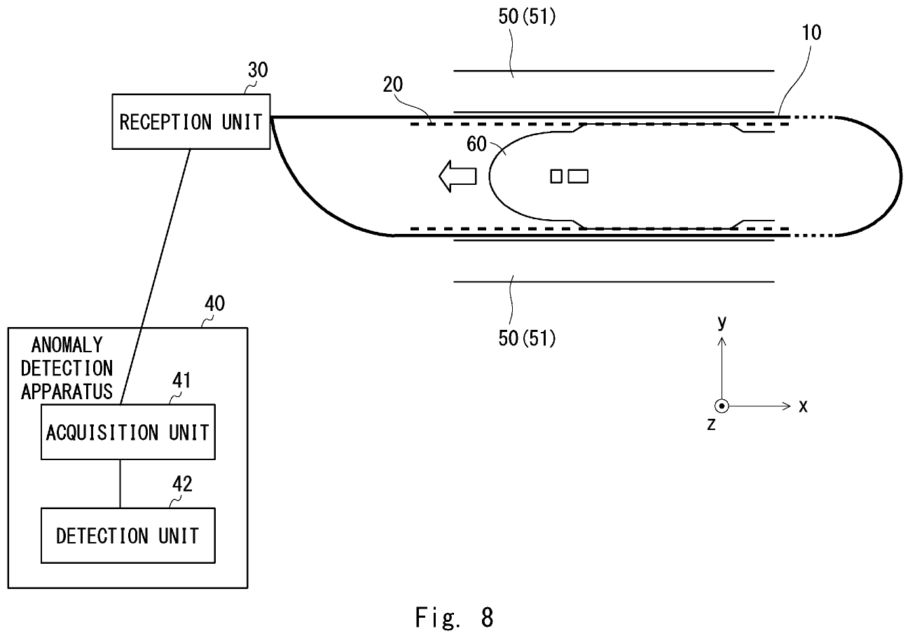

Further, in FIGS. 3 to 7, although two optical fibers 10 are respectively installed in the vehicle 60 on the left and right sides thereof (both sides thereof in the y direction), the present disclosure is not limited thereto. When it is necessary to detect an anomaly of the vehicle 60 or the guideway 50 on only one of the left and right sides (the positive side or the negative side in the y direction) of the vehicle 60, one optical fiber 10 may be installed on only one of the left and right sides of the vehicle 60. Further, as shown in FIG. 8, one optical fiber 10 may be installed so as to surround the vehicle 60 and an area around the vehicle 60. In this case, it is possible to detect an anomaly of the vehicle 60 or the guideway 50 on both right and left sides of the vehicle 60 (both sides thereof in the y direction) by one optical fiber 10.

Further, the optical fiber 10 may be an optical fiber dedicated to sensing or an optical fiber used for both communication and sensing. When the optical fiber 10 is an optical fiber for both communication and sensing, an optical signal for sensing is demultiplexed by a filter (not shown) at the previous stage of the reception unit 30, so that the reception unit 30 can receive only the optical signal for sensing.

The reception unit 30 receives an optical signal, i.e., an optical signal for sensing (hereinafter, an optical signal) from the optical fiber 10. For example, the reception unit 30 receives, as an optical signal, backscattered light generated by making pulsed light incident on the optical fiber 10 and transmitting it through the optical fiber 10.

As described above, a magnetic force is generated between the vehicle 60 and the side wall 51 of the guideway 50 during the traveling of the vehicle 60 by the magnetic reaction between the superconducting magnet 61 and the propulsion coil 52 and the levitation/guide coil 53.

Further, the metal wire 20 made of a magnetic material, such as iron, nickel, or cobalt, which reacts with a magnetic force, is provided between the vehicle 60 and the side wall 51 of the guideway 50. By doing so, the metal wire 20 generates vibration, heat, and sound due to the effect of the above-mentioned magnetic force during the traveling of the vehicle 60.

Further, vibration, heat generation temperature, and sound generated in the metal wire 20 are transmitted to the optical fiber 10 in close contact with the metal wire 20 due to the effect of the magnetic force. As a result, the backscattered light generated when the pulse light made incident on the optical fiber 10 is transmitted through the optical fiber 10 changes, and thus the characteristics of the optical signal received by the reception unit 30 change.

Therefore, the optical fiber 10 can detect the effect of the magnetic force received by the metal wire 20, and thus the optical signal received by the reception unit 30 includes information indicating the effect of the magnetic force received by the metal wire 20, the information being detected by the optical fiber 10. Note that the information indicating the effect of the magnetic force received by the metal wire 20 may be information indicating at least one of vibration, heat generation temperature, and sound.

Note that, in the vehicle 60 and the guideway 50, an anomaly may occur, for example, at the timing when the current is made to flow through the superconducting magnet 61 and the propulsion coil 52, or in the switching operation of the magnetic poles of the propulsion coil 52. Further, an anomaly such as deterioration of the superconducting magnet 61, the propulsion coil 52, and the levitation/guide coil 53 or an installation of suspicious objects on the guideway 50 may occur. When such an anomaly has occurred, the magnetic force generated between the vehicle 60 and the side wall 51 of the guideway 50 changes, and as a result, the effect of the magnetic force received by the metal wire 20 also changes.

Therefore, a detection unit 42 can detect an anomaly of the vehicle 60 or the guideway 50 by analyzing information indicating the effect of the magnetic force received by the metal wire 20, the information being included in the optical signal received by the reception unit 30.

Therefore, the acquisition unit 41 acquires information indicating the effect of the magnetic force received by the metal wire 20, the information being included in the optical signal received by the reception unit 30. Then the detection unit 42 detects an anomaly of the vehicle 60 or the guideway 50 based on the information indicating the effect of the magnetic force received by the metal wire 20, the information being acquired by the acquisition unit 41.

Note that the time at which the vehicle 60 passes the guideway 50, that is, the time at which an anomaly can be detected, varies in accordance with the length, the speed, and the like of the vehicle 60. Therefore, in order to ensure a constant diagnostic accuracy, the transmission (incidence) period of the pulse light may be changed in accordance with the number of vehicles 60, the traveling speed of the vehicle 60, and the like.

An example of a method by which the detection unit 42 detects an anomaly of the vehicle 60 or the guideway 50 will be described in detail below.

Information indicating the effect of the magnetic force received by the metal wire 20, which information is detected by the optical fiber 10, includes a vibration pattern of the vibration, a temperature pattern of the heat generation temperature, and an acoustic pattern of the sound, which vibration, heat generation temperature, and sound are generated in the metal wire 20 due to the effect of the magnetic force. The above vibration pattern, temperature pattern, and acoustic pattern are fluctuation patterns which dynamically fluctuate. Further, when an anomaly has occurred in the vehicle 60 or the guideway 50, the vibration pattern, the temperature pattern, and the acoustic pattern are fluctuation patterns, each of which is unique to the type of the anomaly that has occurred. Among these patterns, for example, the vibration pattern is a unique fluctuation pattern in which the transitions in the fluctuations in the strength of the vibration, the position of the vibration, the number of times of vibrations, and the like differ in accordance with the type of the anomaly that has occurred.

That is, when an anomaly has occurred in the vehicle 60 or the guideway 50, information indicating the effect of the magnetic force received by the metal wire 20, which information is detected by the optical fiber 10, includes the unique vibration pattern, temperature pattern, and acoustic pattern which dynamically fluctuate in accordance with the type of the anomaly that has occurred. By utilizing this feature, the detection unit 42 detects an anomaly of the vehicle 60 or the guideway 50 by the following methods. One example in which an anomaly of the vehicle 60 or the guideway 50 is detected using the vibration pattern will be described below.

### (A) Method A

For each type of an anomaly to be detected, the detection unit 42 stores a vibration pattern of vibration which is actually generated in the metal wire 20 when the anomaly has occurred and is detected by the detection unit 42 as a matching pattern in advance in a memory or the like (not shown).

First, the acquisition unit 41 acquires information indicating the effect of the magnetic force received by the metal wire 20, the information being included in the optical signal received by the reception unit 30.

Next, the detection unit 42 compares the vibration pattern included in the information acquired by the acquisition unit 41 with the matching pattern. When there is a matching pattern in which the matching rate with the vibration pattern is equal to or larger than a threshold among the matching patterns, the detection unit 42 determines that an anomaly corresponding to the matching pattern has occurred.

### (B) Method B

For each type of an anomaly to be detected, the detection unit 42 prepares a set of training data indicating the anomaly and a vibration pattern of vibration which is actually generated in the metal wire 20 when the anomaly has occurred and is detected by the detection unit 42. Then the detection unit 42 inputs the prepared sets to construct a learning model by a Convolutional Neural Network (CNN) in advance, and stores the learning model in a memory or the like (not shown) in advance.

First, the acquisition unit 41 acquires information indicating the effect of the magnetic force received by the metal wire 20, the information being included in the optical signal received by the reception unit 30.

Next, the detection unit 42 inputs the vibration pattern included in the information acquired by the acquisition unit 41 to the learning model. By doing so, when an anomaly to be detected has occurred in the vehicle 60 or the guideway 50, the detection unit 42 obtains information about the anomaly that has occurred in the vehicle 60 or the guideway 50 as a result output from the learning model.

As described above, according to the above-described methods A and B, the detection unit 42 can not only determine that an anomaly has occurred in the vehicle 60 or the guideway 50, but can also specify the type of the anomaly that has occurred.

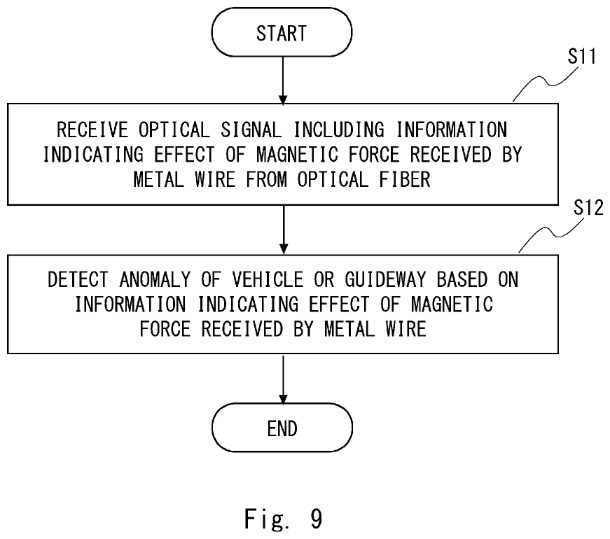

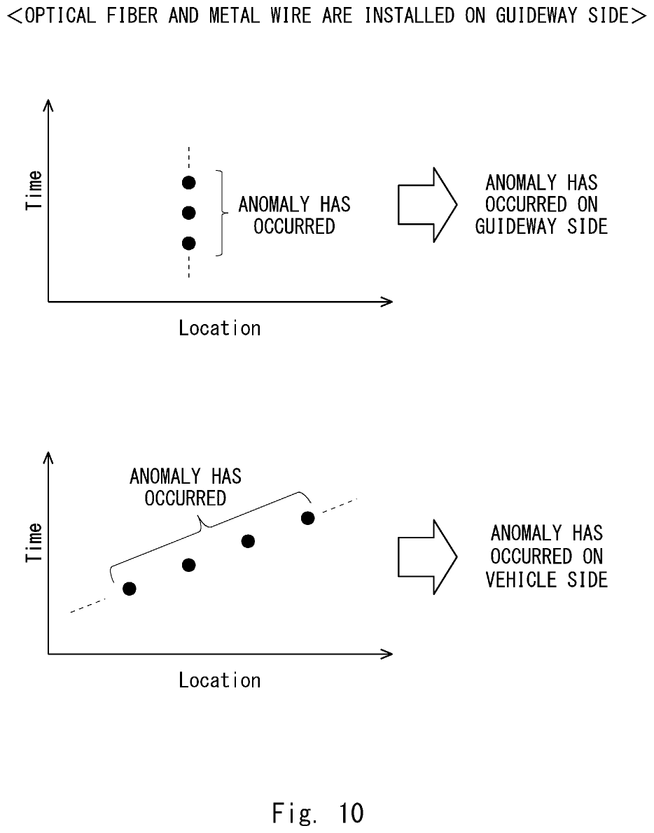

Next, an example of a flow of operations performed by the anomaly detection system according to the first example embodiment will be described with reference to FIG. 9.

As shown in FIG. 9, the reception unit 30 receives, from the optical fiber 10 that detects a state of the metal wire 20 affected by a magnetic force generated between the vehicle 60 and the guideway 50, an optical signal including information indicating the effect of the magnetic force received by the metal wire 20 (Step S11).

Next, the acquisition unit 41 acquires information indicating the effect of the magnetic force received by the metal wire 20, the information being included in the optical signal received by the reception unit 30, and the detection unit 42 detects an anomaly of the vehicle 60 or the guideway 50 based on the information indicating the effect of the magnetic force received by the metal wire 20 (Step S12). This Step S12 may be performed, for example, by using one of the above-described methods A and B.

As described above, according to the first example embodiment, the reception unit 30 receives, from the optical fiber 10 that detects a state of the metal wire 20 affected by a magnetic force generated between the vehicle 60 and the guideway 50 of the magnetically levitated train, an optical signal including information indicating the effect of the magnetic force received by the metal wire 20. The detection unit 42 detects an anomaly of the vehicle 60 or the guideway 50 based on information indicating the effect of the magnetic force received by the metal wire 20, the information being included in the optical signal.

In this way, it is possible to detect an anomaly of the vehicle 60 or the guideway 50 of the magnetically levitated train.

Further, since the anomaly detection apparatus 40 can be located distant from the reception unit 30, it is possible to remotely detect an anomaly of the vehicle 60 or the guideway 50 of the magnetically levitated train in real time.

### Second Example Embodiment

Although the configuration of an anomaly detection system according to a second example embodiment is similar to that of the first example embodiment described above, the number of functions of the detection unit 42 included therein is increased.

In the first example embodiment described above, although the detection unit 42 can determine that an anomaly has occurred in the vehicle 60 or the guideway 50, it cannot determine whether the anomaly has occurred in the vehicle 60 or it has occurred in the guideway 50.

Therefore, in the second example embodiment, the detection unit 42 has an additional function of determining, when it determines that an anomaly has occurred in the vehicle 60 or the guideway 50, whether the anomaly has occurred in the vehicle 60 or it has occurred in the guideway 50. Further, the detection unit 42 has an additional function of specifying an occurrence location where the anomaly has occurred.

An example of a method by which the detection unit 42 determines whether an anomaly has occurred in the vehicle 60 or it has occurred in the guideway 50 and an example of a method by which the detection unit 42 specifies an occurrence location where the anomaly has occurred will be described in detail below. Note that these methods change according to whether the optical fiber 10 and the metal wire 20 are installed on the guideway 50 side or on the vehicle 60 side. Therefore, the method in the case in which the optical fiber 10 and the metal wire 20 are installed on the guideway 50 side and the method in the case in which they are installed on the vehicle 60 side will each be respectively described below.

(a) Case in which the Optical Fiber 10 and the Metal Wire 20 are Installed on the Guideway 50 Side

First, an example of the above-described method in the case in which the optical fiber 10 and the metal wire 20 are installed on the guideway 50 side will be described with reference to FIG. 10. Note that FIG. 10 shows an example in which a magnetically levitated train composed of a plurality of vehicles 60 connected thereto travels along the optical fiber 10 in a direction away from the reception unit 30.

The detection unit 42 can specify the position (the distance of the optical fiber 10 from the reception unit 30) where an optical signal is generated by using the following method. For example, the detection unit 42 can specify the position where an optical signal is generated based on a time difference between the time when the reception unit 30 makes the pulse light incident on the optical fiber 10 and the time when the reception unit 30 receives the optical signal from the optical fiber 10. Alternatively, the detection unit 42 can specify the position where the optical signal is generated based on the reception strength of the optical signal received by the reception unit 30. For example, the detection unit 42 specifies that the smaller the reception strength of the optical signal becomes, the farther the position where the optical signal is generated is from the position of the reception unit 30. Note that the specification of the location where the optical signal is generated is not limited to being performed by the detection unit 42. For example, the reception unit 30 may specify the location where the optical signal is generated, and the acquisition unit 41 may acquire information about the location where the optical signal is generated from the reception unit 30.

The detection unit 42 can specify the position (the distance of the optical fiber 10 from the reception unit 30) where an optical signal is generated by using the method described above. Therefore, the detection unit 42 can specify an optical signal generated at any position.

In this example, a plurality of sensing points are set at predetermined intervals on the optical fiber 10 installed on the guideway 50 side. Then the detection unit 42 specifies an optical signal generated at each of the plurality of sensing points, and detects an anomaly of the vehicle 60 or the guideway 50 based on information indicating the effect of the magnetic force received by the metal wire 20, the information being included in the specified optical signal.

It is assumed that when an anomaly is detected at the sensing point on the optical fiber 10 installed on the guideway 50 side, the position of the sensing point (the distance of the optical fiber 10 from the reception unit 30) and the time when the anomaly is detected at the sensing point are specified and the specified position and time are plotted on a graph. Then, for example, a graph showing characteristics as shown in FIG. 10 is obtained.

In the example shown in the upper part of FIG. 10, an anomaly is continuously detected a plurality of times at one sensing point on the optical fiber 10 installed on the guideway 50 side. In this case, the detection unit 42 determines that an anomaly has occurred on the guideway 50 side. Further, the detection unit 42 specifies the position of the sensing point where the anomaly is detected as a location where the anomaly has occurred. Note that, in the example shown in the upper part of FIG. 10, the detection unit 42 determines, when an anomaly is detected only at one sensing point on the optical fiber 10, that the anomaly has occurred on the guideway 50 side. However, the present disclosure is not limited thereto. For example, the detection unit 42 may determine, when an anomaly is detected only at a predetermined number or less of sensing points on the optical fiber 10, that the anomaly has occurred on the guideway 50 side.

On the other hand, in the example shown in the lower part of FIG. 10, an anomaly is detected continuously over time at a plurality of sensing points on the optical fiber 10 installed on the guideway 50 side. In this case, the detection unit 42 determines that an anomaly has occurred on the vehicle 60 side. Further, the detection unit 42 acquires, from a management center or the like that manages the magnetically levitated train, position information of the vehicle 60 at the time when the anomaly is detected at any sensing point among the plurality of sensing points where the anomaly is detected. Then the detection unit 42 specifies which part (part in the x direction) of the vehicle 60 has passed through any sensing point on the guideway 50 side at the time when the anomaly is detected, and specifies (i.e., determines) the specified part of the vehicle 60 as a location where the anomaly has occurred.

(b) Case in which the Optical Fiber 10 and the Metal Wire 20 are Installed on the Vehicle 60 Side

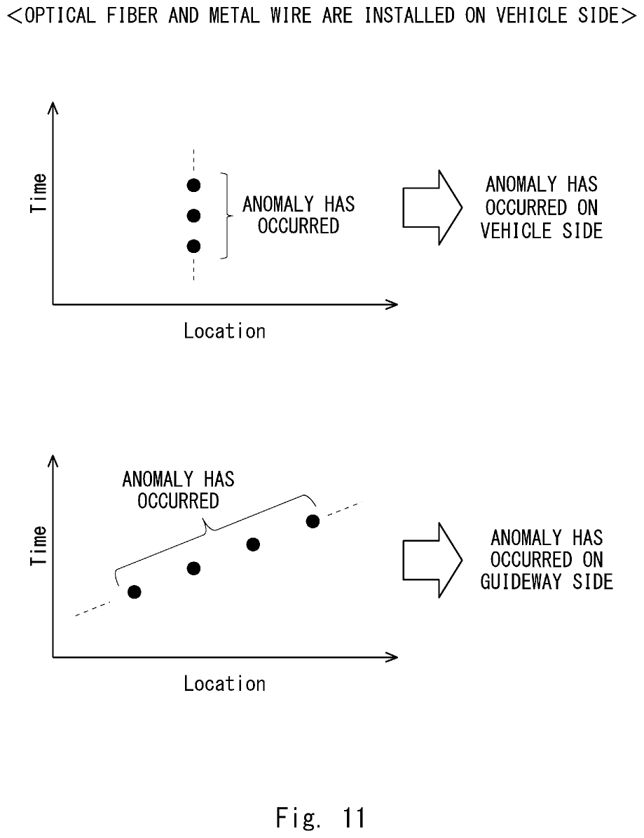

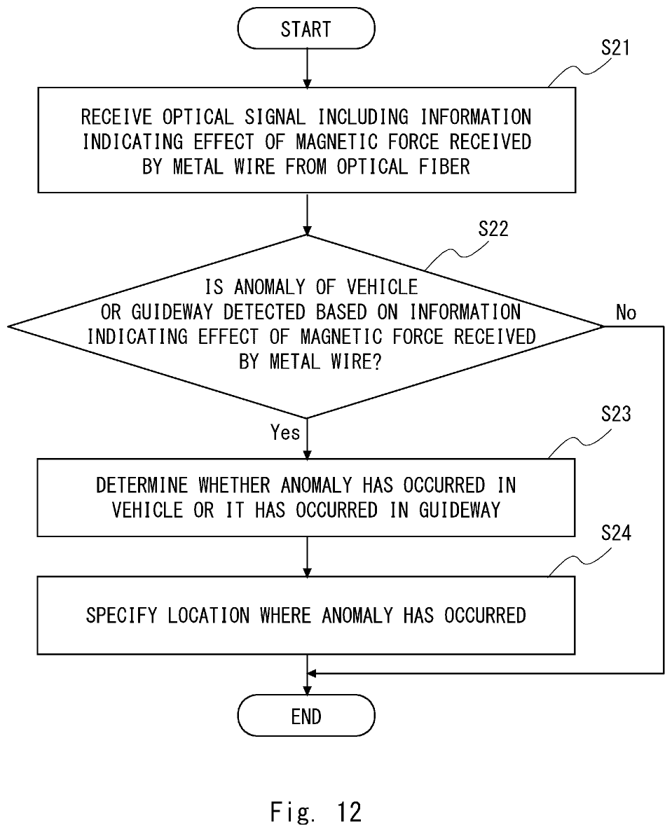

Next, an example of the above-described method in the case in which the optical fiber 10 and the metal wire 20 are installed on the vehicle 60 side will be described with reference to FIG. 11. Note that FIG. 11 shows an example in which a magnetically levitated train composed of a plurality of vehicles 60 connected thereto travels along the optical fiber 10 in a direction away from the reception unit 30.

In this example, like in the case of FIG. 10, a plurality of sensing points are set at predetermined intervals on the optical fiber 10 installed on the vehicle 60 side. Then the detection unit 42 specifies an optical signal generated at each of the plurality of sensing points, and detects an anomaly of the vehicle 60 or the guideway 50 based on information indicating the effect of the magnetic force received by the metal wire 20, the information being included in the specified optical signal.

Further, like in the case of FIG. 10, it is assumed that when an anomaly is detected at the sensing point on the optical fiber 10 installed on the vehicle 60 side, the position of the sensing point (the distance of the optical fiber 10 from the reception unit 30) and the time when the anomaly is detected at the sensing point are specified and the specified position and time are plotted on a graph. Then, for example, a graph showing characteristics as shown in FIG. 11 is obtained.

In the example shown in the upper part of FIG. 11, an anomaly is continuously detected a plurality of times at one sensing point on the optical fiber 10 installed on the vehicle 60 side. In this case, the detection unit 42 determines that an anomaly has occurred on the vehicle 60 side. Further, the detection unit 42 specifies the position of the sensing point where the anomaly is detected as a location where the anomaly has occurred. Note that, in the example shown in the upper part of FIG. 11, the detection unit 42 determines, when an anomaly is detected only at one sensing point on the optical fiber 10, that the anomaly has occurred on the vehicle 60 side. However, the present disclosure is not limited thereto. For example, the detection unit 42 may determine, when an anomaly is detected only at a predetermined number or less of sensing points on the optical fiber 10, that the anomaly has occurred on the vehicle 60 side.

On the other hand, in the example shown in the lower part of FIG. 11, an anomaly is detected continuously over time at a plurality of sensing points on the optical fiber 10 installed on the vehicle 60 side. In this case, the detection unit 42 determines that an anomaly has occurred on the guideway 50 side. Further, the detection unit 42 acquires, from a management center or the like, position information of the vehicle 60 at the time when the anomaly is detected at any sensing point among the plurality of sensing points where the anomaly is detected. Then the detection unit 42 specifies which part (part in the x-direction) of the guideway 50 any sensing point on the vehicle 60 side has passed at the time when the anomaly is detected, and specifies (i.e., determines) the specified part of the guideway 50 as a location where the anomaly has occurred.

Next, an example of a flow of operations performed by the anomaly detection system according to the second example embodiment will be described with reference to FIG. 12.

As shown in FIG. 12, the reception unit 30 receives, from the optical fiber 10 that detects a state of the metal wire 20 affected by a magnetic force generated between the vehicle 60 and the guideway 50, an optical signal including information indicating the effect of the magnetic force received by the metal wire 20(Step S21).

Next, the acquisition unit 41 acquires information indicating the effect of the magnetic force received by the metal wire 20, the information being included in the optical signal received by the reception unit 30, and the detection unit 42 detects an anomaly of the vehicle 60 or the guideway 50 based on the information indicating the effect of the magnetic force received by the metal wire 20 (Step S22). This Step S22 may be performed, for example, by using one of the above-described methods A and B.

If the detection unit 42 determines in Step S22 that an anomaly has occurred in the vehicle 60 or the guideway 50 (Yes in Step S22), then it determines whether the anomaly has occurred in the vehicle 60 or it has occurred in the guideway 50 based on the optical signal received by the reception unit 30 (Step S23). Further, the detection unit 42 specifies an occurrence location where the anomaly has occurred based on the optical signal received by the reception unit 30 and the position of the vehicle 60 when the anomaly has occurred (Step S24). These Steps S23 and S24 may be performed, for example, by using one of the methods described with reference to FIG. 10 or FIG. 11.

As described above, according to the second example embodiment, when the detection unit 42 determines that an anomaly has occurred in the vehicle 60 or the guideway 50 of the magnetically levitated train, it determines whether the anomaly has occurred in the vehicle 60 or it has occurred in the guideway 50 based on the optical signal received by the reception unit 30. Further, the detection unit 42 specifies an occurrence location where the anomaly has occurred based on the optical signal received by the reception unit 30 and the position of the vehicle 60 when the anomaly has occurred.

By doing so, it is possible to determine whether an anomaly has occurred in the vehicle 60 of the magnetically levitated train or it has occurred in the guideway 50 of the magnetically levitated train and to specify the location where the anomaly has occurred.

Effects other than the above ones are similar to those of the above-described first example embodiment.

### Third Example Embodiment

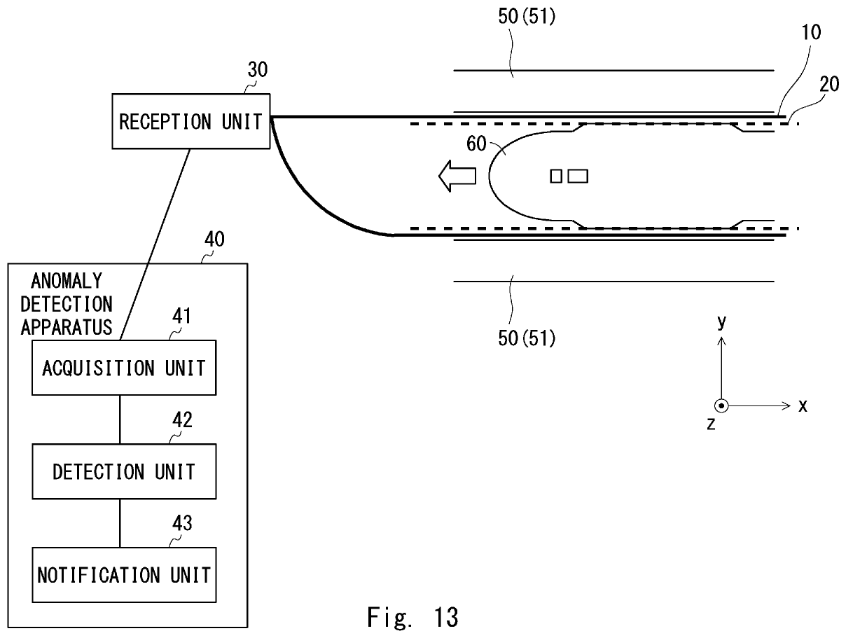

Next, a configuration example of an anomaly detection system according to a third example embodiment will be described with reference to FIG. 13.

As shown in FIG. 13, the configuration of the anomaly detection system according to the third example embodiment differs from the above-described configurations of the first and the second example embodiments in that a notification unit 43 is additionally provided inside the anomaly detection apparatus 40. In FIG. 13, two optical fibers 10 are respectively installed in the vehicle 60 on the left and right sides thereof (both sides thereof in the y direction). However, as shown in FIG. 8, one optical fiber 10 may be installed so as to surround the vehicle 60 and an area around the vehicle 60. In this case, it is possible to detect, on both right and left sides of the vehicle 60 (both sides of the vehicle 60 in the y direction), an anomaly of the vehicle 60 or the guideway 50 by one optical fiber 10.

When the detection unit 42 determines that an anomaly has occurred in the vehicle 60 or the guideway 50, the notification unit 43 notifies a notification destination terminal (not shown) that the anomaly has occurred. The notification destination terminal is, for example, a terminal installed in a management center that manages the magnetically levitated train, a station, a train operator's cabin of the vehicle 60, or a terminal carried by a train operator who operates the magnetically levitated train. As the notification method, for example, a method in which a Graphical User Interface (GUI) screen is displayed on a display, a monitor, or the like of the notification destination terminal, and a method in which a message is output by voice from a speaker of the notification destination terminal may be employed.

Further, like in the case of the second example embodiment described above, when the detection unit 42 has a function of determining whether an anomaly has occurred in the vehicle 60 or it has occurred in the guideway 50, and a function of specifying an occurrence location where the anomaly has occurred, the notification unit 43 may, in addition to sending the above-described notification, notify the terminal about whether the anomaly has occurred in the vehicle 60 or it has occurred in the guideway 50, and may notify the terminal about the location where the anomaly has occurred.

Further, like in the case of the second example embodiment described above, when the detection unit 42 has a function of determining whether an anomaly has occurred in the vehicle 60 or it has occurred in the guideway 50, the notification unit 43 may notify the notification destination terminal that an anomaly has occurred, which notification destination terminal differs depending on whether the anomaly has occurred in the vehicle 60 or it has occurred in the guideway 50. For example, it is conceivable that the notification unit 43 may send a notification to a terminal installed in a train operator's cabin or a terminal carried by a train operator when an anomaly has occurred in the vehicle 60, while it may send a notification to a terminal installed in a management center or a station when an anomaly has occurred in the guideway 50.

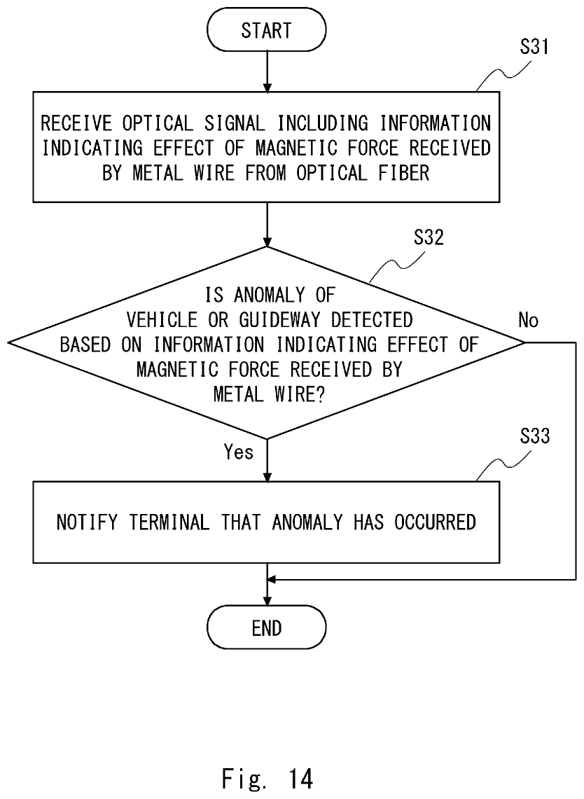

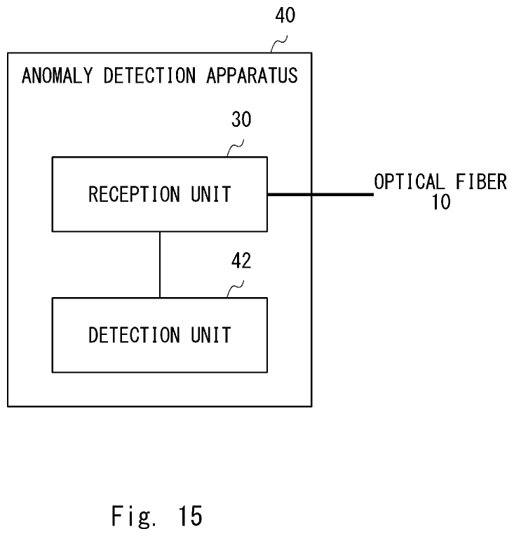

Next, an example of a flow of operations performed by the anomaly detection system according to the third example embodiment will be described with reference to FIG. 14.

As shown in FIG. 14, the reception unit 30 receives, from the optical fiber 10 that detects a state of the metal wire 20 affected by a magnetic force generated between the vehicle 60 and the guideway 50, an optical signal including information indicating the effect of the magnetic force received by the metal wire 20 (Step S31).

Next, the acquisition unit 41 acquires information indicating the effect of the magnetic force received by the metal wire 20, the information being included in the optical signal received by the reception unit 30, and the detection unit 42 detects an anomaly of the vehicle 60 or the guideway 50 based on the information indicating the effect of the magnetic force received by the metal wire 20 (Step S32). This Step S32 may be performed, for example, by using one of the above-described methods A and B.

If the detection unit 42 determines in Step S32 that an anomaly has occurred in the vehicle 60 or the guideway 50 (Yes in Step S32), then the notification unit 43 notifies a notification destination terminal that the anomaly has occurred (Step S33). At this time, if the detection unit 42 has the above-described function according to the second example embodiment, the notification unit 43 may, in addition to sending the above-described notification, notify the terminal about whether the anomaly has occurred in the vehicle 60 or it has occurred in the guideway 50, and may notify the terminal about the location where the anomaly has occurred. Further, the notification unit 43 may notify the notification destination terminal that an anomaly has occurred, which notification destination terminal differs depending on whether the anomaly has occurred in the vehicle 60 or it has occurred in the guideway 50.

As described above, according to the third example embodiment, when the detection unit 42 determines that an anomaly has occurred in the vehicle 60 or the guideway 50 of the magnetically levitated train, the notification unit 43 notifies a notification destination terminal that the anomaly has occurred.

By doing so, it is possible to notify the notification destination terminal that an anomaly has occurred in the vehicle 60 or the guideway 50 of the magnetically levitated train.

Effects other than the above ones are similar to those of the above-described first example embodiment.

### Other Example Embodiments

In the above-described example embodiments, when the optical fiber 10 and the metal wire 20 are installed on the vehicle 60 side, the optical fiber 10 and the metal wire 20 are installed on the side surface of the vehicle 60. However, the present disclosure is not limited thereto. The optical fiber 10 and the metal wire 20 may be installed at a position where the metal wire 20 is affected by a magnetic force generated between the vehicle 60 and the side wall 51 of the guideway 50. Therefore, the optical fiber 10 and the metal wire 20 may be installed at a position in an upper part or a lower part of the vehicle 60 where the metal wire 20 is affected by the magnetic force. Further, the optical fiber 10 and the metal wire 20 are not limited to being installed outside the vehicle 60, and may be installed inside the vehicle 60 at a position where the metal wire 20 is affected by the magnetic force.

Further, in the above-described example embodiments, when an anomaly has occurred in the vehicle 60 or the guideway 50, the notification unit 43 notifies a notification destination terminal that the anomaly has occurred. However, the present disclosure is not limited thereto. When an anomaly has occurred in the vehicle 60 or the guideway 50, the vehicle 60 may be controlled so that, for example, the speed of the vehicle 60 is reduced or the vehicle 60 is stopped. Such control of the vehicle 60 may be performed by a control unit (not shown) or by the notification unit 43.

Further, in the above-described example embodiments, the detection unit 42 may periodically detect an anomaly of the vehicle 60 or the guideway 50. At this time, the detection unit 42 may specify the state of the vehicle 60 or the guideway 50 and maintain the specified state even when it determines that no anomaly has occurred based on information indicating the effect of the magnetic force received by the metal wire 20. Then the detection unit 42 may detect a sign of an anomaly of the vehicle 60 or the guideway 50 based on changes in the state over time.

Further, in the above-described example embodiments, the detection unit 42 detects an anomaly of the vehicle 60 or the guideway 50 based on the effect of the magnetic force received by the metal wire 20. However, the present disclosure is not limited thereto. For example, when the optical fiber 10 is installed on the guideway 50 side, the optical fiber 10 can detect the passage of the vehicle 60, landslides, the entry of animals and persons into the guideway 50, vibrations caused by earthquakes etc., the temperature of the guideway 50 itself, abnormal noises in the surroundings of the guideway 50, and the like, and these information pieces detected by the optical fiber 10 are also included in the optical signal. Therefore, the detection unit 42 may detect the passage of the vehicle 60, landslides, and the like based on these information pieces. Further, when the optical fiber 10 is installed on the vehicle 60 side, the optical fiber 10 can detect vibrations and the temperature of the vehicle 60 itself, sounds of the vehicle 60 itself during traveling or stopping, and the like, and these information pieces detected by the optical fiber 10 are also included in the optical signal. Therefore, the detection unit 42 may detect the state of the vehicle 60 based on these information pieces.

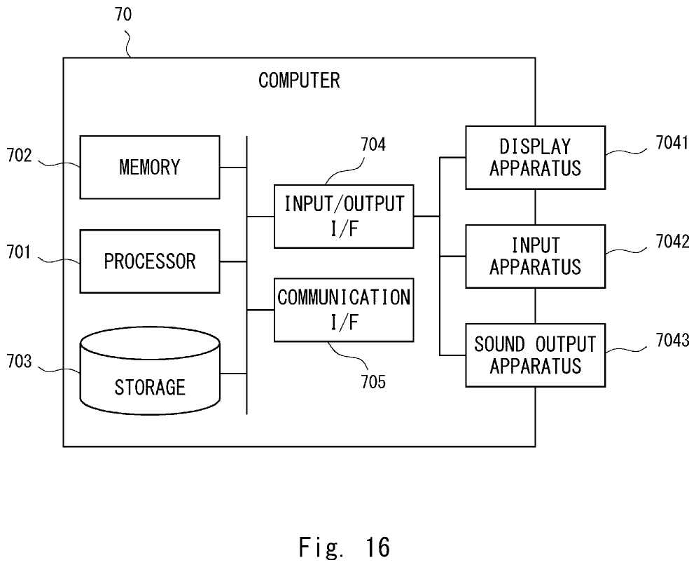

Further, in the above-described example embodiments, the reception unit 30 and the anomaly detection apparatus 40 are separated. However, the present disclosure is not limited thereto. The reception unit 30 and the anomaly detection apparatus 40 may be integrated with each other, so that the reception unit 30 is provided inside the anomaly detection apparatus 40. FIG. 15 shows a configuration example of an anomaly detection system in which the reception unit 30 is provided inside the anomaly detection apparatus 40. In the example of FIG. 15, since the reception unit 30 and the detection unit 42 are provided inside the same anomaly detection apparatus 40, the acquisition unit 41 is removed. Note that, in the anomaly detection system shown in FIG. 15, like in the case of the third example embodiment described above, the notification unit 43 may be additionally provided inside the anomaly detection apparatus 40.

Further, in the above-described example embodiments, one reception unit 30 and one anomaly detection apparatus 40 are provided in two optical fibers 10 installed in the vehicle 60 on both right and left sides thereof (both sides thereof in the y direction) or in one optical fiber 10 installed so as to surround the vehicle 60 and an area around the vehicle 60. However, the present disclosure is not limited thereto. For example, when a plurality of optical fibers 10 are provided, a plurality of reception units 30 and a plurality of anomaly detection apparatuses 40, each of which corresponds to a respective one of the plurality of optical fibers 10, may be provided.

### <Hardware Configuration of the Anomaly Detection Apparatus According to the Example Embodiments>

Next, a hardware configuration of a computer 70 that implements the anomaly detection apparatus 40 according to the above-described example embodiments will be described with reference to FIG. 16.

As shown in FIG. 16, the computer 70 includes a processor 701, a memory 702, a storage 703, an input/output interface (an input/output I/F) 704, a communication interface (communication I/F) 705, and the like. The processor 701, the memory 702, the storage 703, the input/output interface 704, and the communication interface 705 are connected to each other through data transmission lines through which they transmit/receive data to/from each other.

The processor 701 is, for example, an arithmetic processing unit such as a Central Processing Unit (CPU) or a Graphics Processing Unit (GPU). The memory 702 is, for example, a memory such as a Random Access Memory (RAM) or a Read Only Memory (ROM). The storage 703 is, for example, a storage device such as a Hard Disk Drive (HDD), a Solid State Drive (SSD), or a memory card. Further, the storage 703 may be a memory such as a RAM or a ROM.

The storage 703 stores programs for implementing the functions of the components included in the anomaly detection apparatus 40. The processor 701 implements the function of each of the components included in the anomaly detection apparatus 40 by executing the respective programs. Note that when the processor 701 executes these respective programs, it may execute the programs after loading them onto the memory 702 or may execute the programs without loading them onto the memory 702. Further, the memory 702 and the storage 703 also have a function of storing information and data held by the components included in the anomaly detection apparatus 40.

Further, the above-described program(s) can be stored and provided to a computer (including the computer 70) using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Compact Disc-ROM), CD-R (CD-Recordable), CD-R/W (CD-ReWritable), and semiconductor memories (such as mask ROM, PROM (Programmable ROM), EPROM (Erasable PROM), flash ROM, RAM, etc.). Further, the program(s) may be provided to a computer using any type of transitory computer readable media. Examples of transitory computer readable media include electric signals, optical signals, and electromagnetic waves. Transitory computer readable media can provide the program(s) to a computer via a wired communication line (e.g., electric wires and optical fibers) or a wireless communication line.

The input/output interface 704 is connected to a display apparatus 7041, an input apparatus 7042, a sound output apparatus 7043, and the like. The display apparatus 7041 is an apparatus, such as a Liquid Crystal Display (LCD), a Cathode Ray Tube (CRT) display, or a monitor, which displays an image corresponding to drawing data processed by the processor 701. The input apparatus 7042 is an apparatus that receives an operation input from an operator, and is, for example, a keyboard, a mouse, and a touch sensor. The display apparatus 7041 and the input apparatus 7042 may be integrated with each other and hence implemented as a touch panel. The sound output apparatus 7043 is an apparatus, such as a speaker, which outputs sounds corresponding to acoustic data processed by the processor 701.

The communication interface 705 transmits and receives data to and from an external apparatus. For example, the communication interface 705 communicates with an external apparatus through a wired communication line or a wireless communication line.

Although the present disclosure has been described with reference to the example embodiments, the present disclosure is not limited to the above-described example embodiments. Various changes that may be understood by those skilled in the art may be made to the configurations and details of the present disclosure within the scope of the disclosure.

For example, the whole or part of the above example embodiments may be used in combination with each other.

Further, the whole or part of the example embodiments disclosed above can be described as, but not limited to, the following supplementary notes.

(Supplementary Note 1)

An anomaly detection system comprising:

an optical fiber configured to detect a state of a metal member affected by a magnetic force generated between a vehicle and a guideway of a magnetically levitated train;

a reception unit configured to receive, from the optical fiber, an optical signal including information indicating an effect of the magnetic force received by the metal member; and

a detection unit configured to detect an anomaly of the vehicle or the guideway based on the information indicating the effect of the magnetic force received by the metal member, the information being included in the optical signal.

(Supplementary Note 2)

The anomaly detection system according to Supplementary note 1, wherein the information indicating the effect of the magnetic force received by the metal member includes at least one of vibration, heat generation temperature, and sound of the metal member generated by the magnetic force.

(Supplementary Note 3)

The anomaly detection system according to Supplementary note 1 or 2, wherein when the detection unit determines that an anomaly has occurred in the vehicle or the guideway, the detection unit determines whether the anomaly has occurred in the vehicle or it has occurred in the guideway based on the optical signal.

(Supplementary Note 4)

The anomaly detection system according to Supplementary note 3, wherein when the detection unit determines that an anomaly has occurred in the vehicle or the guideway, the detection unit specifies an occurrence location where the anomaly has occurred based on the optical signal and a position of the vehicle at a time when the anomaly has occurred.

(Supplementary Note 5)

The anomaly detection system according to Supplementary note 3 or 4, further comprising a notification unit configured to send, when the detection unit determines that an anomaly has occurred in the vehicle or the guideway, a notification that the anomaly has occurred.

(Supplementary Note 6)

The anomaly detection system according to Supplementary note 5, wherein the notification unit notifies a notification destination terminal that an anomaly has occurred, which notification destination terminal differs depending on whether the anomaly has occurred in the vehicle or it has occurred in the guideway.

(Supplementary Note 7)

An anomaly detection apparatus comprising:

an acquisition unit configured to acquire information indicating an effect of a magnetic force received by a metal member, the information being included in an optical signal received from an optical fiber configured to detect a state of the metal member affected by the magnetic force generated between a vehicle and a guideway of a magnetically levitated train; and

a detection unit configured to detect an anomaly of the vehicle or the guideway based on the information indicating the effect of the magnetic force received by the metal member.

(Supplementary Note 8)

The anomaly detection apparatus according to Supplementary note 7, wherein the information indicating the effect of the magnetic force received by the metal member includes at least one of vibration, heat generation temperature, and sound of the metal member generated by the magnetic force.

(Supplementary Note 9)

The anomaly detection apparatus according to Supplementary note 7 or 8, wherein when the detection unit determines that an anomaly has occurred in the vehicle or the guideway, the detection unit determines whether the anomaly has occurred in the vehicle or it has occurred in the guideway based on the optical signal.

(Supplementary Note 10)

The anomaly detection apparatus according to Supplementary note 9, wherein when the detection unit determines that an anomaly has occurred in the vehicle or the guideway, the detection unit specifies an occurrence location where the anomaly has occurred based on the optical signal and a position of the vehicle at a time when the anomaly has occurred.

(Supplementary Note 11)

The anomaly detection apparatus according to Supplementary note 9 or 10, further comprising a notification unit configured to send, when the detection unit determines that an anomaly has occurred in the vehicle or the guideway, a notification that the anomaly has occurred.

(Supplementary Note 12)

The anomaly detection apparatus according to Supplementary note 11, wherein the notification unit notifies a notification destination terminal that an anomaly has occurred, which notification destination terminal differs depending on whether the anomaly has occurred in the vehicle or it has occurred in the guideway.

(Supplementary Note 13)

An anomaly detection method performed by an anomaly detection system, the anomaly detection method comprising:

a reception step of receiving, from an optical fiber configured to detect a state of a metal member affected by a magnetic force generated between a vehicle and a guideway of a magnetically levitated train, an optical signal including information indicating an effect of the magnetic force received by the metal member; and

a detection step of detecting an anomaly of the vehicle or the guideway based on the information indicating the effect of the magnetic force received by the metal member, the information being included in the optical signal.

(Supplementary Note 14)

The anomaly detection method according to Supplementary note 13, wherein the information indicating the effect of the magnetic force received by the metal member includes at least one of vibration, heat generation temperature, and sound of the metal member generated by the magnetic force.

(Supplementary Note 15)

The anomaly detection method according to Supplementary note 13 or 14, wherein in the detection step, when it is determined that an anomaly has occurred in the vehicle or the guideway, it is determined whether the anomaly has occurred in the vehicle or it has occurred in the guideway based on the optical signal.

(Supplementary Note 16)

The anomaly detection method according to Supplementary note 15, wherein in the detection step, when it is determined that an anomaly has occurred in the vehicle or the guideway, an occurrence location where the anomaly has occurred is specified based on the optical signal and a position of the vehicle at a time when the anomaly has occurred.

(Supplementary Note 17)

The anomaly detection method according to Supplementary note 15 or 16, further comprising a notification step of sending, when it is determined in the detection step that an anomaly has occurred in the vehicle or the guideway, a notification that the anomaly has occurred.

(Supplementary Note 18)

The anomaly detection method according to Supplementary note 17, wherein in the notification step, a notification that an anomaly has occurred is sent to a notification destination terminal, which notification destination terminal differs depending on whether the anomaly has occurred in the vehicle or it has occurred in the guideway.

This application is based upon and claims the benefit of priority from Japanese patent application No. 2020-060394, filed on Mar. 30, 2020, the disclosure of which is incorporated herein in its entirety by reference.

### REFERENCE SIGNS LIST

10 OPTICAL FIBER
20 METAL WIRE
30 RECEPTION UNIT
40 ANOMALY DETECTION APPARATUS
41 ACQUISITION UNIT
42 DETECTION UNIT
43 NOTIFICATION UNIT
50 GUIDEWAY
51 SIDE WALL
52 PROPULSION COIL
53 LEVITATION/GUIDE COIL
60 VEHICLE
61 SUPERCONDUCTING MAGNET
70 COMPUTER
701 PROCESSOR
702 MEMORY
703 STORAGE
704 INPUT/OUTPUT INTERFACE
7041 DISPLAY APPARATUS
7042 INPUT APPARATUS
7043 SOUND OUTPUT APPARATUS
705 COMMUNICATION INTERFACE

What is claimed is:

1. An anomaly detection system comprising:
an optical fiber configured to detect a state of a metal member affected by a magnetic force generated between a vehicle and a guideway of a magnetically levitated train;
a reception unit configured to receive, from the optical fiber, an optical signal including information indicating an effect of the magnetic force received by the metal member; and
a detection unit configured to detect an anomaly of the vehicle or the guideway based on the information indicating the effect of the magnetic force received by the metal member, the information being included in the optical signal.

2. The anomaly detection system according to claim 1, wherein the information indicating the effect of the magnetic force received by the metal member includes at least one of vibration, heat generation temperature, and sound of the metal member generated by the magnetic force.

3. The anomaly detection system according to claim 1, wherein when the detection unit determines that an anomaly has occurred in the vehicle or the guideway, the detection unit determines whether the anomaly has occurred in the vehicle or it has occurred in the guideway based on the optical signal.

4. The anomaly detection system according to claim 3, wherein when the detection unit determines that an anomaly has occurred in the vehicle or the guideway, the detection unit specifies an occurrence location where the anomaly has occurred based on the optical signal and a position of the vehicle at a time when the anomaly has occurred.

5. The anomaly detection system according to claim 3, further comprising a notification unit configured to send, when the detection unit determines that an anomaly has occurred in the vehicle or the guideway, a notification that the anomaly has occurred.

6. The anomaly detection system according to claim 5, wherein the notification unit notifies a notification destination terminal that an anomaly has occurred, which notification destination terminal differs depending on whether the anomaly has occurred in the vehicle or it has occurred in the guideway.

7. An anomaly detection apparatus comprising:
an acquisition unit configured to acquire information indicating an effect of a magnetic force received by a metal member, the information being included in an optical signal received from an optical fiber configured to detect a state of the metal member affected by the magnetic force generated between a vehicle and a guideway of a magnetically levitated train; and
a detection unit configured to detect an anomaly of the vehicle or the guideway based on the information indicating the effect of the magnetic force received by the metal member.

8. The anomaly detection apparatus according to claim 7, wherein the information indicating the effect of the magnetic force received by the metal member includes at least one of vibration, heat generation temperature, and sound of the metal member generated by the magnetic force.

9. The anomaly detection apparatus according to claim 7, wherein when the detection unit determines that an anomaly has occurred in the vehicle or the guideway, the detection unit determines whether the anomaly has occurred in the vehicle or it has occurred in the guideway based on the optical signal.

10. The anomaly detection apparatus according to claim 9, wherein when the detection unit determines that an anomaly has occurred in the vehicle or the guideway, the detection unit specifies an occurrence location where the anomaly has occurred based on the optical signal and a position of the vehicle at a time when the anomaly has occurred.

11. The anomaly detection apparatus according to claim 9, further comprising a notification unit configured to send, when the detection unit determines that an anomaly has occurred in the vehicle or the guideway, a notification that the anomaly has occurred.

12. The anomaly detection apparatus according to claim 11, wherein the notification unit notifies a notification destination terminal that an anomaly has occurred, which notification destination terminal differs depending on whether the anomaly has occurred in the vehicle or it has occurred in the guideway.

13. An anomaly detection method performed by an anomaly detection system, the anomaly detection method comprising:
a reception step of receiving, from an optical fiber configured to detect a state of a metal member affected by a magnetic force generated between a vehicle and a guideway of a magnetically levitated train, an optical signal including information indicating an effect of the magnetic force received by the metal member; and
a detection step of detecting an anomaly of the vehicle or the guideway based on the information indicating the effect of the magnetic force received by the metal member, the information being included in the optical signal.

14. The anomaly detection method according to claim 13, wherein the information indicating the effect of the magnetic force received by the metal member includes at least one of vibration, heat generation temperature, and sound of the metal member generated by the magnetic force.

15. The anomaly detection method according to claim 13, wherein in the detection step, when it is determined that an anomaly has occurred in the vehicle or the guideway, it is determined whether the anomaly has occurred in the vehicle or it has occurred in the guideway based on the optical signal.

16. The anomaly detection method according to claim 15, wherein in the detection step, when it is determined that an anomaly has occurred in the vehicle or the guideway, an occurrence location where the anomaly has occurred is specified based on the optical signal and a position of the vehicle at a time when the anomaly has occurred.

17. The anomaly detection method according to claim 15, further comprising a notification step of sending, when it is determined in the detection step that an anomaly has occurred in the vehicle or the guideway, a notification that the anomaly has occurred.

18. The anomaly detection method according to claim 17, wherein in the notification step, a notification that an anomaly has occurred is sent to a notification destination terminal, which notification destination terminal differs depending on whether the anomaly has occurred in the vehicle or it has occurred in the guideway.
